(19) United States
(12) Patent Application Publication
(10) Pub. No.: US 2014/0032431 A1
(43) Pub. Date: Jan. 30, 2014

(54) System and Method for Resolving Warrants

(71) Applicant: THE REGENTS OF THE UNIVERSITY OF MICHIGAN, Ann Arbor, MI (US)

(72) Inventors: Benjamin Gubernick, Tucson, AZ (US); James J. Prescott, Northville, MI (US); Daniel Katz, Ann Arbor, MI (US)

(73) Assignee: THE REGENTS OF THE UNIVERSITY OF MICHIGAN, Ann Arbor, MI (US)

(21) Appl. No.: 13/951,087

(22) Filed: Jul. 25, 2013

Related U.S. Application Data
(60) Provisional application No. 61/675,687, filed on Jul. 25, 2012.

(51) Int. Cl. G06Q 50/26; G06Q 10/10

(52) U.S. Cl. CPC G06Q 50/26; G06Q 10/10
USPC 705/311

(57) ABSTRACT

Systems and methods automatically resolve outstanding arrest warrants. Users may login to an automated system and answer a series of questions from an adaptive questionnaire module. Based on the user's answers, a bargained for deal may be selected from a payout matrix module and presented to the user. The user may have the option of accepting or rejecting the proposed deal, and if the user accepts the proposed deal, the deal and other relevant information may be sent to a government official for further processing if necessary.

### CROSS-REFERENCE TO RELATED APPLICATIONS

This application claims priority benefit of U.S. Provisional Application 61/675,687, entitled “System and Method for Resolving Warrants,” filed Jul. 25, 2012, the disclosure of which is incorporated herein by reference.

### FIELD OF THE DISCLOSURE

This disclosure relates to warrants, and in particular, to automatically resolving unresolved warrants.

### BACKGROUND

Governments nationwide manage large arrest warrant and bench warrant backlogs. While the term “warrant” when used in this context invokes images of suspects alleged to have committed serious crimes, a large majority of arrest warrants and bench warrants are issued for minor matters, such as, for example, failure to appear in court for a low-grade misdemeanor offense or a missed show-cause hearing stemming from an unpaid fine. While the exact number of warrants for relatively minor offenses is unclear, they are known to number in the tens of millions in the United States.

State, county, and municipal officials often give these minor warrants little attention, preferring to devote scarce law enforcement resources to more serious matters. That is, governments often decide that the resources required to actively enforce the warrant exceed the direct benefits to the government, the government's agents, or society. As a result, governments often rely on relatively passive enforcement methods, such as suspending delinquent litigants' driver's licenses, cutting off welfare benefits, or performing arrests during routine traffic stops.

However, placing a low-priority on warrant enforcement is far from costless for governments and litigants. As resolutions of the matters underlying warrants typically involve cash transfers from wanted individuals to governments, failing to resolve warrants deprives governments of a significant source of revenue. Further, maintaining large warrant backlogs is a source of substantial political embarrassment, and can result in members of the public viewing the judiciary less seriously. Additionally, “wanted” individuals may engage in socially costly avoidance behavior or suffer other costs over long periods of time. These costs to litigants include a reluctance to interact with law enforcement, difficulty passing background checks, and persistent low-grade fear of apprehension and severe sanction.

Further, these costs for litigants are exacerbated by the fact that individuals with unresolved warrants often choose not to self-surrender out of perceived risk. Courts generally have broad discretion in deciding what sanctions to impose for the matters underlying warrants, and delinquent litigants, perhaps believing they already have “strikes against them,” frequently opt to avoid dealing with their warrants indefinitely.

Governments have, on occasion, attempted to encourage litigants with outstanding issues to resolve their problems through incentive schemes. These include amnesty programs, which provide litigants with windows of time to resolve their warrants in exchange for a fixed benefit, such as waiver of some fees or guaranteed entry into a repayment program. However, governments generally offer such programs infrequently out of concern that deterrence will be compromised; future compliance may be reduced if people come to believe that the severe potential punishments which may accompany failure to perform on a court ordered obligation are, in reality, hollow threats.

Further still, for a variety of reasons, the negotiated surrender of individuals with unresolved warrants with relatively minor offenses almost never occurs. First, retaining private counsel is expensive, which prices individuals with unresolved warrants out of the market entirely. Additionally, courts and prosecutors (for warrants for unresolved criminal matters) are generally unwilling to negotiate surrender on a case-by-case basis for minor matters. Given resource constraints (e.g., the time involved in back-and-forth communication between a court and an at-large litigant), and the relatively minor nature of the matters at issue, it is often not worth the time of a judge or prosecutor to negotiate.

### SUMMARY

In an example, a device includes a processing unit; a memory unit; and a warrant resolution module. The warrant resolution module retrieves login information from a device user. Using the login information, the warrant resolution module confirms that the device user is authorized to use an automated warrant resolution system and then presents the user with a customized series of one or more questions. The customized series of questions may be about the user's identity and/or background, the incident or incidents which led to the warrants, and/or the form or forms of relief, i.e., deals, that the user would be interested in receiving. The warrant resolution module may adjust the series of presented questions based on received user responses and/or a series of deals stored in a data matrix. After presenting the customized series of one or more questions and receiving corresponding responses from the user, the warrant resolution module may determine a proposed warrant resolution deal and may present the user with the proposed warrant resolution deal and request that the user accept or reject the deal.

In another example, a tangible non-transitory computer-readable medium has instructions stored thereon that, when executed by a processor, cause the processor to receive login information from a system user. The processor also determines from the login information whether the system user is authorized to use an automated warrant resolution system. After confirming that the user is authorized to use the automated warrant resolution system, the processor presents the user with a customized series of one or more questions. The customized series of questions may be about the user's background, the incident or incidents which led to the arrest warrants, and/or the form or forms of relief, i.e., deals, that the user would be interested in receiving. The processor adjusts the series of one or more questions based on received user responses and/or a series of deals stored in a data matrix. After presenting the customized series of one or more questions and receiving corresponding responses from the system user, the processor may determine a proposed warrant resolution deal and may present the user with the proposed warrant resolution deal and request that the user accept or reject the deal.

In yet another example, a method in a computing device having a processor includes using the processor to receive login information from a system user. In the method, the processor is also used to determine from the login information whether the system user is authorized to use an automated warrant resolution system and present the user with a customized series of one or more questions after confirming that the user is authorized. The customized series of questions may be about the user's background, the incident or incidents which led to the arrest warrants, and/or the form or forms of relief, i.e., deals, that the user would be interested in receiving. As part of the method, the processor also adjusts the series of one or more questions based on received user responses and/or a series of deals stored in a data matrix. After presenting the customized series of one or more questions and receiving corresponding responses from the system user, the processor may determine a proposed warrant resolution deal and may present the user with the proposed warrant resolution deal and request that the user accept or reject the deal.

A device includes a processing unit; a memory unit; and a conflict resolution module. The conflict resolution module retrieves login information from a device user. Using the login information, the conflict resolution module confirms that the device user is authorized to use an automated conflict resolution system and then presents the user with a customized series of one or more questions. The customized series of questions may be about the user's identity and/or background, the incident or incidents which led to the conflict, and/or one or more conflict resolution deals that may be presented to the user. The conflict resolution module may adjust the series of presented questions based on received user responses and/or a series of deals stored in a data matrix. After presenting the customized series of one or more questions and receiving corresponding responses from the user, the conflict resolution module may determine a proposed conflict resolution deal and may present the user with the proposed warrant resolution deal and request that the user accept or reject the deal.

### BRIEF DESCRIPTION OF THE DRAWINGS

FIG. 1 depicts a flow diagram providing an overview of an example method for automatically resolving a warrant according to the present disclosure;

FIG. 2 depicts a block diagram of an example device configured to perform automated warrant resolution according to the present disclosure;

FIG. 3 depicts an example adaptive questionnaire module according to the present disclosure;

FIG. 4 depicts an example payout matrix module according to the present disclosure

FIG. 5 depicts an example decision module according to the present disclosure; and

FIG. 6 depicts a flow diagram illustrating another example method for automatically resolving a warrant according to the present disclosure.

### DETAILED DESCRIPTION

A system and method allow a user to automatically resolve an unresolved warrant. The system and method may be self-contained (i.e., the system and method may not require any outside intervention to automatically process and approve a warrant resolution) or may require further outside involvement (e.g., a judge or local law enforcement official may be required to approve an automatically generated warrant resolution). As used in this document, “warrant” refers to any order issued by a court or other governmental organization authorizing the detention of the person named therein, including bench warrants, misdemeanor warrants, felony warrants, including, for example, warrants resulting from delinquency as described herein.

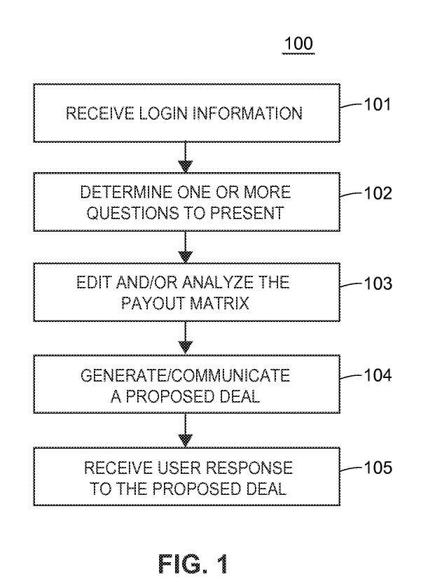

Generally, the described system and method may be used by users to automatically resolve one or more unresolved warrants for minor crimes and civil infractions. FIG. 1 depicts a flow diagram providing a general overview of the process 100 wherein a user may log on to a system using unique identification such as, for example, a social security number, a driver's license number or a unique online username and/or password (block 101). This information is then used for identity verification and to provide the user with a customized warrant resolution process.

After the user's identity is verified, the described system and method can automatically cross-reference identification information and a list of active arrest warrants and/or criminal record information associated with the user and present the user with a set of customized warrant resolution questions (block 102). The cross-referencing may be performed, for example, with either publicly available data or with data made available for this purpose by a government. The customized warrant resolution questions may initially be related to background information about the user's identity and the incident or incidents which led to the user's unresolved warrant or warrants. The customized questions may act as the functional equivalent of a defense attorney's intake interview and may be used to collect information necessary to determine the likely consequences of the user's surrender and what, if any, incentives may be offered to the user in order to induce a favorable resolution.

The customized questions may be contained within an adaptive questionnaire module, which may interact with a payout matrix module that includes a payout matrix, e.g., acceptable deals, that the user may agree to as part of the warrant resolution process. More specifically, the payout matrix module may include a listing that includes a number of deals the user may agree to in order to resolve his unresolved warrant or warrants (e.g., performing community service, paying a monetary penalty, serving limited jail or prison time, etc.). The deals or formulae for determining the deals contained within the payout matrix module may be determined in advance by identifying different classes of offenders and/or criminal offenses and assigning allowable deals for the government to offer (e.g., payout matrices for users with unresolved warrants for drug offenses may be populated with a different set of deals than payout matrices for users with unresolved warrants for parking tickets). Based on user answers to questions presented by the questionnaire module, the payout matrix may be edited accordingly (block 103). For example, if the user indicates that he would not agree to pay a monetary penalty to resolve his unresolved warrant, deals that involve paying a fine may be removed from the payout matrix module and/or may not be considered when offering a final deal to the system user.

The adaptive questionnaire module and the payout matrix module may both interact with a decision module. The decision module may be used to interpret user responses to questions from the adaptive questionnaire module and to modify and/or select elements from the payout matrix accordingly. More specifically, the decision module may verify that the user's answers to questions from the questionnaire module are accurate (e.g., answers to introductory questions about the user's identity and the incident or incidents underlying the unresolved warrant should match with answers stored in the user's profile matrix or in another data structure containing data about the user). The decision module may also remove or edit available deals in the payout matrix module as described above. Additionally, the decision module may add elements of “randomization” to the warrant resolution process. For example, the decision module may remove deals from the payout matrix module even if the user indicates that he is open to those deals as part of a bargained for resolution. The decision module may also decide which specific questions should be presented from the adaptive questionnaire module to the user as part of the adaptive questionnaire. For example, after the user is presented with introductory questions regarding his identity and the basis for his unresolved warrant, the decision module may select which question to present the user with next. As with the payout matrix module, there may be an element of randomness in the selection of questions that are presented to the user from the adaptive questionnaire module.

After a series of one or more questions has been presented to the user, the decision module may generate and communicate a warrant resolution deal to an eligible user (block 104). The offer may be conditional on the accuracy of the user's answers to the questionnaire. This adds an additional layer of security to the system and method, in case the decision module fails to catch one or more inaccurate answers. The surrender incentive offers may be “pre-approved,” so that no further action is required by any government actor in order for a given user to be offered an enforceable agreement. Discretionary review by a government agent after the offer is presented to the user is also possible. In some instances, the user's answers to the questionnaire may render him ineligible for any of the deals stored in the payout matrix module (e.g., through his answers, the user indicates that he is not interested in or qualified for any of the deals stored in the payout matrix module). In such instances, a notice may be sent automatically to the user's account informing the user that he is not eligible for the automated warrant resolution program. Additionally, although the time period between submission of the questionnaire and delivery of an offer could be nearly instantaneous when pre-approval is in place, an artificial delay of several hours or days may be implemented. Like the random elements in the payout matrix module, this artificial time delay may preserve an appearance of individualization, especially if combined with a discretionary review policy (in which some percentage of offers are reviewed and potentially adjusted by the government), as the user would not know that his offer was produced automatically.

The described methods can be implemented in a warrant resolution module operating in a computing device, for example. More generally, the warrant resolution module may operate in any suitable system having a processor capable of receiving and manipulating user responses in response to an adaptive questionnaire. Optionally, the warrant resolution module may operate on the processor itself. The warrant resolution module may receive login information from a device user, confirm that the user is authorized to use the automated warrant resolution system and then present the user with a customized series of one or more questions in the form of an adaptive questionnaire. The warrant resolution module may adjust the series of one or more questions based on received user responses and data stored in a data matrix. After presenting the customized series of one or more questions and receiving corresponding responses from the system user, the warrant resolution module may present the user with a proposed warrant resolution deal and may then receive the user's response to the proposed warrant resolution deal (block 105).

Generally speaking, the techniques of the present disclosure can be applied to resolve arrest warrants for minor offenses (e.g., traffic violations, missed court dates, misdemeanor drug offenses, etc.) but may be used in the context of more serious offenses or in conjunction with more traditional techniques for resolving unresolved warrants. More broadly, the techniques of the present disclosure may be applied to any number of negotiable transactions, of which warrant resolution is an example. For example, the techniques may be adapted to high-volume, qualitatively repetitive, low-margin transactions between a single seller and numerous buyers such as college admission negotiations, financial aid negotiations, and the like. Dynamically created, potential offers for a user may be contained in a payout matrix module that is used to present the user with a subset of offers from which to select from, to complete the financial transaction. Even in the context of the embodiments illustrated here, the techniques may be used for further changes. For example, if monetary fines are involved in resolution of an arrest, warrant, etc., an offer could be generated dynamically based on the likelihood of a specified event. For example, based on a number of factors (e.g., user answers, user history, historical performance of similar users, etc.), a “likelihood to perform” and a “likelihood to reoffend” may be calculated for a given user and a monetary fine offer available to that user may be adjusted accordingly (i.e., eligibility or terms of a resolution containing a cash payment to the government may be adjusted based on the litigant's likelihood to perform on the agreement or reoffend in the future). Indeed, even in the context of the criminal/civil law, the present techniques may be used for negotiating financial transactions, without reference to the “warrant” per se. For example, people who owe money to the IRS may use the disclosed techniques to resolve their debts. Additionally, self-reporting of regulatory violations (such as improper deductions on taxes), and crime reporting more generally might be possible.

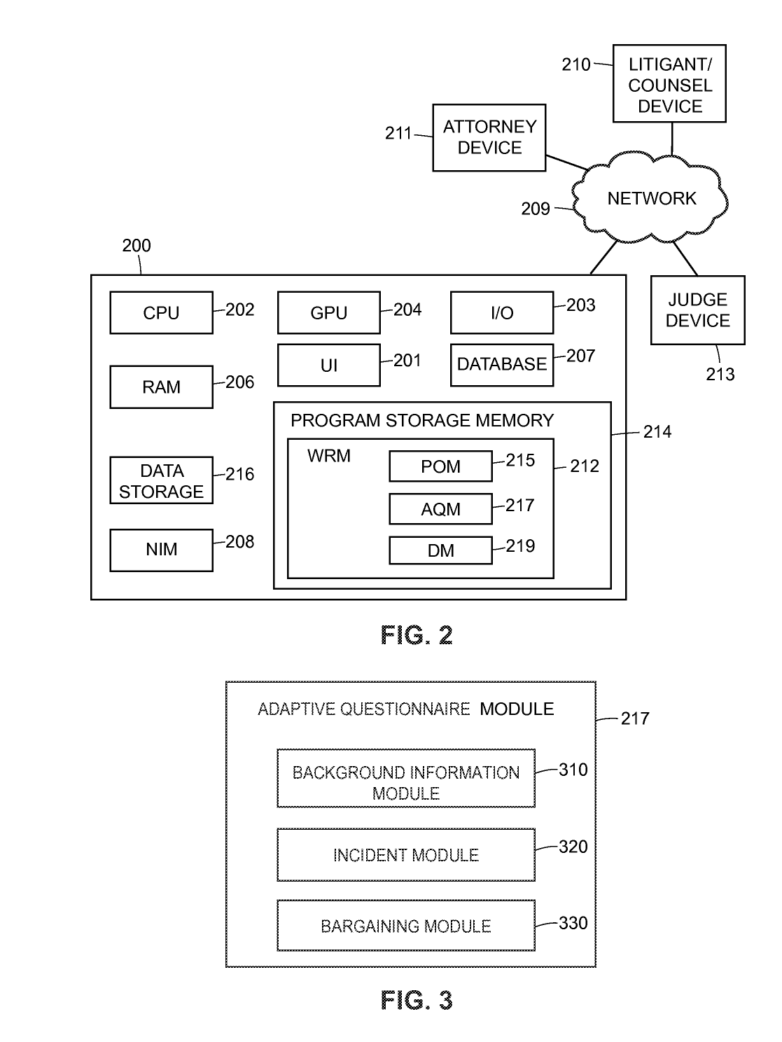

FIG. 2 depicts a block diagram of an example device for performing automated arrest warrant resolution according to the present disclosure. An example device 200 may be a portable device such as a smartphone, a personal digital assistant (PDA), a tablet personal computer (PC), a laptop computer, a handheld game console, etc., or a non-portable computing device such as a desktop computer or, in some implementations, a server. The device 200 may include one or more processors, such as a central processing unit (CPU) 202, to execute software instructions. The software instructions may be stored on a program storage memory 214, which may be a hard drive, an optical drive, a solid state memory device, or any other non-volatile memory device. The software instructions may retrieve data from a data storage 216, which may likewise be any non-volatile data storage device, including a database 207 that is part of device 200 or external to device 200. During execution, the software instructions may be stored in, and may store and retrieve data from, a volatile or non-volatile memory source, such as a random access memory (RAM) 206.

The device 200 may include one or more input/output ports 203 for facilitating communication with other devices as well as a user interface 201 to facilitate human-machine interaction. The user interface 201 may include a display screen (e.g., touch sensitive), keyboard, scroll button, and a like. The device 200 may also include a network interface module (NIM) 208 for facilitating wired and/or wireless communications with a network 209. The network interface module 208 may allow the device 200 to communicate with one or more other similar devices (not shown) using one or more of any number of communications protocols including, by way of example and not limitation, Ethernet, cellular telephony, IEEE 802.11 (i.e., “Wi-Fi”), Fibre Channel, etc. The network interface module 208 may communicatively couple the device 200 to server and/or client devices.

The program storage memory 214 may store a warrant resolution module (WRM) 212 executed by the CPU 202 to perform automatic resolution of unresolved warrants. The warrant resolution module 212 may be a sub-routine of a software application or may be an independent software routine in and of itself. Alternatively, in some implementations, warrant resolution module 212 may be a hardware module or a firmware module. The warrant resolution module 212 may include compiled instructions directly executable by the CPU 202, scripted instructions that are interpreted at runtime, or both. The device 200 may also include a graphics processing unit (GPU) 204 dedicated to rendering images to be displayed on the user interface 201, e.g., display screen. The warrant resolution module 212 may contain one or more of a payout matrix module (POM) 215, an adaptive questionnaire module (AQM) 217, and/or a decision module (DM) 219.

The warrant resolution module 212 may process warrant resolution data according to the presently described techniques. More specifically, the warrant resolution module 212 may automatically resolve unresolved warrants based on stored and received warrant data. The warrant resolution module 212 may process warrant resolution data in response to data received from the user. In instances where the warrant resolution module 212 executes on a server device, the calculated resolutions and/or intermediate calculation results may be sent to a client device. Additionally, the warrant resolution module 212 may perform certain calculations on a server device while other calculations are performed on a client device. For example, the warrant resolution module 212 may verify user entries on a server device but may adjust questions presented from the adaptive questionnaire module 217 on a client device.

The device 200 may also be communicably coupled via a public or private communication network, e.g., wide area network (internet, local area network, telephone system) to other devices that may be used as part of a warrant resolution system. For example, a litigant and/or litigant's counsel device 210 may allow a litigant user and/or counsel to interact with the device 200 from a remote location in addition to the user interface 201. The litigant device 210 may be a telephone, computing device, mobile phone, computing tablet, etc. capable of facilitating wired or wireless communication with the device 200. The litigant device 210 may be required to be authorized by the owner or coordinator of the device 200 for use with the device. Similar to the litigant device 210, a government agent device, e.g., an attorney device 211 and/or a judge device 213, may be communicably coupled to the device 200. The attorney device 211 and the judge device 213 may be a telephone, computing device, mobile phone, computing tablet, etc. capable of facilitating wired or wireless communication with the device 200. The attorney device 211 and the judge device 213 may be required to be authorized by the owner or coordinator of the device 200 for use with the device. The devices 210, 211, and 213 are illustrated as separate devices, although in other examples, one or more of the devices may be the same device, but with different authorizations. In each example, the device may be authorized using a login and authorization procedure, which may be coordinated through the device 200.

The attorney device 211 may allow a government attorney (e.g., a government prosecutor) to review user files stored on device 200 and/or a remote database such as database 207. In certain implementations, the database 207 may include data about federal and/or local crimes (e.g., names of citizens with unresolved warrants and data about the alleged crimes associated with the warrants). The attorney device 211 may allow the government attorney to review these files both before and/or after a litigant user accesses the device 200 to resolve his unresolved warrant or warrants. Similarly, the judge device 213 may allow a judge to review user files stored on device 200 and/or a remote database such as database 207. Additionally, the judge device 213 may, for example, allow a judge to pre-approve deals stored on the device 200 or on a remote database and/or approve deals after a user has agreed to them, if necessary.

FIG. 3 is a block diagram detailing an example embodiment of the adaptive questionnaire module 217 according to the present disclosure. The adaptive questionnaire module 217 may be a hardware module and/or a firmware module and may include compiled instructions directly executable by the CPU 202, scripted instructions that are interpreted at runtime, or both. The adaptive questionnaire module 217 may include a background information module 310, an incident module 320, and a bargaining module 330, and may generate and store an adaptive questionnaire. The background information module 310, the incident module 320, and the bargaining module 330 may be separate modules or may be combined and may interact with each other and/or with other software, hardware, and/or firmware.

Execution of warrant resolution module 212 may cause the processor 202 to request and/or receive, via the I/O unit 203 and/or a network connection, user login information. After the user login information has been verified by, for example, the decision module 219, the warrant resolution module 212 may present questions from the adaptive questionnaire module 217 to the user. More specifically, the warrant resolution module 212 may initially present the user with questions contained in the background information module 310. These questions may relate, for example, to the user's identity (e.g., questions about the user's social security number, name, date of birth, etc.) and may serve as confirmation that the received user login information was accurate. The user's answers to questions from background module 310 may be used to automatically cross-reference a list of active arrest warrants and criminal record information. Cross-referencing may occur with either publicly available data or with data made available for this purpose by a government. This data may also be contained locally or remotely in the payout matrix module 215.

After the user answers questions from the background information module 310 or concurrent with the presentation of those questions, the warrant resolution module 212 may present the user with questions from the incident module 320. Questions from the incident module 320 may inquire about the offense or matter in question, such as whether the user is wanted on a misdemeanor or felony or civil infraction, whether the offense was non-violent, and the approximate or exact date of the offense. As with the user's answers to questions from the background information module 310, the user's answers to questions from the incident module 320 may be used to automatically cross-reference data regarding the user's active arrest warrants and criminal record information. This data may also be contained locally or remotely in the payout matrix module 215. Questions from the incident module 320 may be broad and common to multiple users, thereby acting as a kind of user verification, or they may be specific and tailored to individual users. If the questions are tailored, they may be stored remotely on a server, for example, or locally on the device 200 and accessed by the background information module 310 and the warrant resolution module 212 after the user's identity is verified. Tailored questions about the offense or matter in question may optionally be pre-approved or reviewed by a government agent.

Finally, after the user answers questions from the background information module 310 and the incident module 320, the warrant resolution module 212 may present the user with questions stored in the bargaining module 330. Questions from the bargaining module 330 may require or invite users to describe what they are willing to do in return for their arrest warrant or warrants being withdrawn or amended. These questions may be menu driven instead of free-form, and may ask, for example, whether the user is willing and able to pay a fine, and if so how much, or whether the user would like a new court date.

The adaptive questionnaire module 217 may include a large number of questions to potentially be presented to the user. The number of questions and the specific questions to be presented may vary based on the user's responses to earlier questions. For example, if the user indicates that he is not interested in a particular deal (e.g., a new court date), follow-up questions about that particular deal may not be presented to the user. Further, if it appears that the user has given an inaccurate answer to a background question, he may be presented with follow-up questions related to the seemingly inaccurate answer.

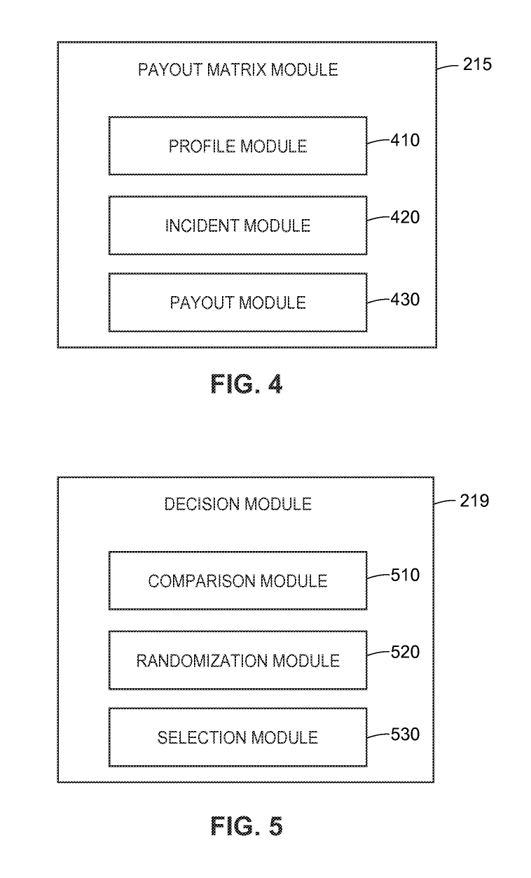

FIG. 4 is a block diagram detailing an example embodiment of the payout matrix module 215 according to the present disclosure. The payout matrix module 215 may be a hardware module and/or a firmware module and may include compiled instructions directly executable by the CPU 202, scripted instructions that are interpreted at runtime, or both. The payout matrix module 215 may include a profile module 410, an incident module 420, and a payout module 430 and may generate and store a payout matrix. The profile module 410, incident module 420, and the payout module 430 may be separate modules or may be combined and may interact with each other and/or with other software, hardware, and/or firmware.

As discussed above, execution of the warrant resolution module 212 may cause the processor 202 to request and/or receive user login information and present questions from the adaptive questionnaire module 217 to the user. The adaptive questionnaire module 217 may interact with the payout matrix module 215 during this process. More specifically, the payout matrix module 215 may include data about the user and/or a set of pre-determined deals, e.g., payout module 430, that the user may agree to at the end of a bargaining process. User background information (e.g., the user's name, social security number, driver's license number, birthday, etc.) may be contained in the profile module 410, and information about the incident or incidents which led to the user's unresolved warrant or warrants may be contained in the incident module 420. Further, the set of predetermined deals that the user may agree to may be contained in the payout module 430.

The values or formulas for determining the values in the payout matrix module 215 may be determined in advance by identifying different classes or groups of offenders and assigning allowable incentives for the government to offer. For example, deals for users with traffic violations may be different from deals for users with missed court dates. The deals contained in the payout module 430 may be approved beforehand by government officials (e.g., a local judge and/or prosecuting attorney). Certain values in the payout matrix module 215 may be generated dynamically. For example, the payout matrix module 215 may access relevant data from an outside source (e.g., statistics about current prison capacity) that may affect deals available to the user or adjust monetary fines based on user responses and/or characteristics, and may then update the stored values accordingly. Additionally, the data contained in the payout module 430 may incorporate information that is not case or offense specific, and is therefore effectively random. For example, a potential deal could depend on the number of fines paid in the last week, the total of fines collected in the last month, the number of cases resolved in any particular day, or the characteristics of immediately preceding cases. This effective randomness generates uncertainty that prosecutors believe is necessary to ensure sufficient general deterrence. Further, the payout module 430 may be modified over time by adjusting entries based on analysis of users' response to different incentives.

As mentioned above, the payout matrix module 215 may interact with both the adaptive questionnaire module 217, and/or the decision module 219. For example, as the user answers questions from the adaptive questionnaire module 217, the decision module 219 may analyze the user's responses and eliminate certain deals contained in the payout matrix module 215 from consideration when presenting the final deal to the user (e.g., if the user indicates that he is not willing to pay a fine, deals that incorporate paying a fine may not be considered when the final deal is presented to the user). Further, the payout matrix module 215 may organize deals based on identified different classes of users (e.g., deals for users with unresolved warrants for drug offenses may be different from deals for users with unresolved warrants for parking tickets). The payout matrix module 215 may contain only a single category of deals (e.g., only deals for users with unresolved warrants for drug offenses) or may contain multiple categories of deals in the same matrix.

FIG. 5 is a block diagram detailing an example embodiment of the decision module 219 according to the present disclosure. The decision module 219 may be a hardware module and/or a firmware module and may include compiled instructions directly executable by the CPU 202, scripted instructions that are interpreted at runtime, or both. The decision module 219 may include a comparison module 510, a randomization module 520, and a selection module 530. The comparison module 510, the randomization module 520, and the selection module 530 may be separate modules or may be combined and may interact with each other and/or with other software, firmware, and/or hardware.

Again, execution of the warrant resolution module 212 may cause the processor 202 to request and/or receive user login information and present questions from the adaptive questionnaire module 217 to the user. The adaptive questionnaire module 217 and the payout matrix module 215 may interact with the decision module 219 during this process. More specifically, the decision module 219 may verify and/or evaluate the user's answers to questions from the adaptive questionnaire module 217 and may select deals contained in the payout matrix module to generate the deal presented to the user at the end of a bargaining process.

Among other things, the comparison module 510 may be used to verify and/or evaluate the user's answers to questions from the adaptive questionnaire module 217. For example, the comparison module 510 may compare the user's answers to the initial background and/or incident questions (e.g., questions about the user's identity and/or questions about the user's unresolved warrant or warrants) with expected user answers. More specifically, the comparison module 510 may compare the user's answers with pre-stored answers about the user's identity and/or the user's unresolved warrant or warrants. The pre-stored answers may be stored, for example in a separate data structure and/or contained in the payout matrix module 215. Based on the user's answers and the comparisons of the user's answers with the pre-stored answers, the comparison module 510 may select which question or questions the user may be presented with next. For example, if the user gives an “unexpected” answer about his identity and/or unresolved warrant or warrants, the decision module 219 may select follow-up questions regarding the user's identity and/or unresolved warrant or warrants from the adaptive questionnaire module 217.

The randomization module 520 may be used to randomize questions presented from adaptive questionnaire module 217 or deals offered based on entries in the payout matrix module 215. The use of “red herrings” and random elements by randomization module 520 preserves the appearance of individualization, as the user cannot easily discover which information was used to determine whether he was eligible for an offer, or the terms of that offer.

As discussed above, the payout matrix module 215 may incorporate information that is not case or offense specific, and is therefore effectively random. The randomization module 520 may communicate with the warrant resolution module 212 in selecting the “random” entries from a database during the pre-population of the payout matrix 215. The use of “red herrings” and random elements by the randomization module 520 preserves the appearance of individualization, as the user cannot easily discover which information was used to determine whether he was eligible for an offer, or the terms of that offer. Similarly, the randomization module 520 may communicate with the warrant resolution module 212 in selecting the questions to be presented to the user from the adaptive questionnaire module 217. For example, the randomization module 520 may communicate with the warrant resolution module 212 when selecting between equally “eligible” questions to be presented.

The selection module 530 may be used in conjunction with the adaptive questionnaire module 217, and/or the decision module 219 to determine the final deal presented to the user at the end of the negotiation process. More specifically, after the presentation of questions to the user is over, the selection module 530 may communicate with the warrant resolution module 212 to generate and communicate a binding surrender incentive deal based on one or more entries in the payout matrix 215. In some instances, a user's answers to the questionnaire may render him ineligible for a binding surrender incentive deal. In such instances, the selection module 530 may communicate with the warrant resolution module 212 to generate and communicate a notice that may be sent automatically to the user's account informing the user that he is not eligible for the program. Additionally, although the time period between submission of the questionnaire and delivery of an offer could be nearly instantaneous when pre-approval is in place, the selection module 530 may communicate with the warrant resolution module 212 to generate and communicate a binding surrender incentive offer after an artificially introduced time delay of several hours or days.

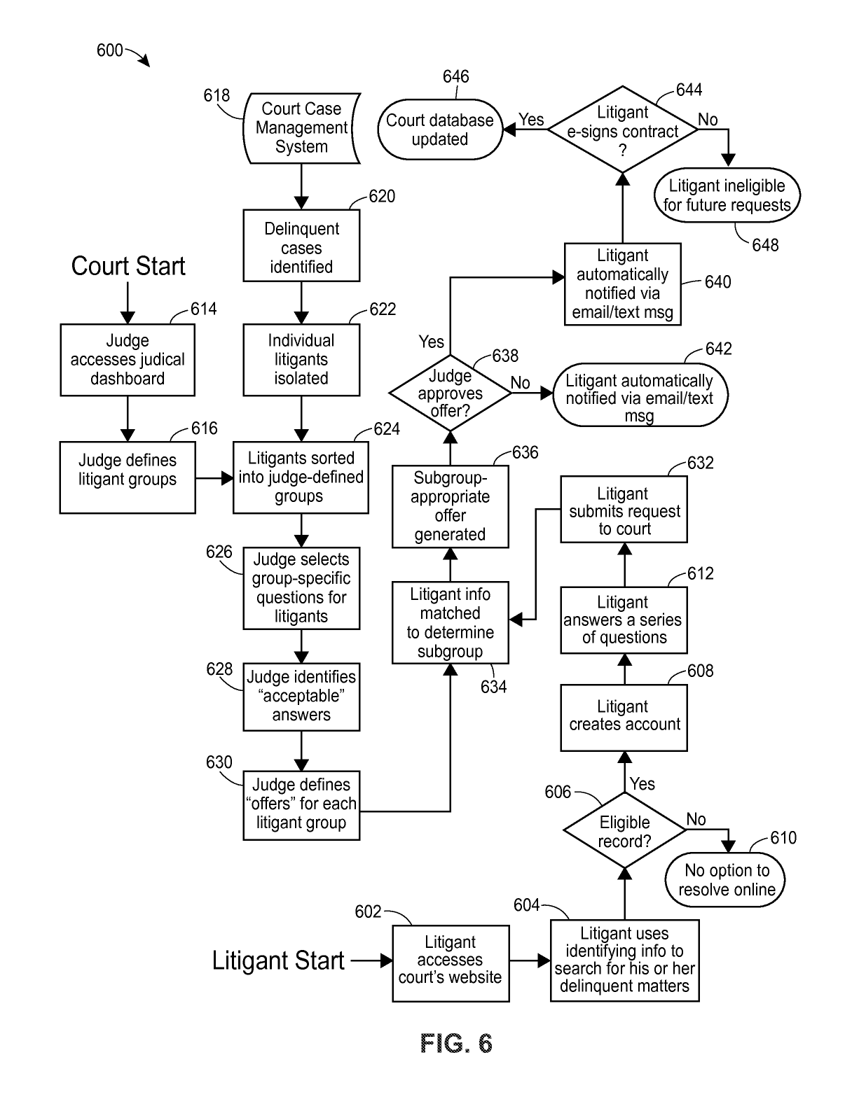

FIG. 6 depicts a flow diagram illustrating another example method for resolving a warrant according to the present disclosure. The method 600 may be performed on one or more devices, for example, the warrant resolution module 212 may be executed on a processor associated with a mobile device or on a processor associated with a server device, or may be executed partially on a processor associated with a client device and partially on a processor associated with a server device. Specifically, the warrant resolution module 212 may execute in a processor of a client device to collect the user's responses to questions from the adaptive questionnaire module 217. The warrant resolution module 212 may also execute in a processor of a server device, retrieving background data and/or expected answers for transmission, in whole or in part, to a client (e.g., a desktop, laptop, tablet, mobile phone) device.

The method 600 includes the warrant resolution module 212 receiving (e.g., by retrieving, by requesting and receiving, etc.) login information from a system user (block 602) and determining from the login information whether the system user is authorized to use an automated warrant resolution system. The login information may take a variety of forms including one or more of the following: user's name, social security number, birthday, driver's license number, and/or a predetermined username, for example. In addition to receiving and processing login information via a computer interface, the warrant resolution module 212 may also be configured to accommodate other forms of input data such as, for example, voice-input through a telephone or a series of text messages. After the user login information has been received, the login information may be verified by, for example, the decision module 219. As part of the verification process, the decision module 219 may compare the received login information with previously stored data. Upon access to the system, the user may search for associated delinquent matters (block 604). Additional information provided by the user may be used to automatically cross-reference a local or remote database including a list of warrants and criminal record information that may be stored in a court case management system (block 618). If a warrant is associated with the litigant user and the warrant is resolvable via the system (block 606), the user may create an account to resolve the matter (block 608) or simply access an existing account. However, if there is no warrant associated with the user, or the warrant is not eligible for resolution via the system, the user cannot utilize the system to resolve the matter (block 610).

After confirming the user's identity, the warrant resolution module 212 may anonymize the user's identity. The anonymizing process ensures the bargaining process is essentially “riskless” for the user. That is, if the government is unable to independently connect the case and other information to a particular user, the user's anonymity is preserved in the event that no agreement regarding the unresolved warrant or warrants is reached. Additionally, the anonymizing process may help ensure that irrelevant, potentially prejudicial information such as the user's race will not be taken into consideration. As part of the anonymizing process, data that could potentially be used to identify the user may, for example, be encrypted and/or stored in a portion of a device memory that would automatically be deleted at the end of the bargaining process in the event that no agreement is reached.

After the user answers questions about his background, the warrant resolution module 212 may present the user with questions about the offense or matter in question, such as, for example, whether the user is wanted on a misdemeanor or felony or civil infraction, whether the offense was non-violent, and the approximate or exact date of the offense. The user may also be presented with questions asking him to describe what he is willing to do in return for his arrest warrant being withdrawn or amended. These questions may be menu driven instead of free-form, and may ask, for example, whether the user is willing and able to pay a fine, and if so how much, or whether the user would like a new court date. The user's answers to these questions may be used to automatically cross-reference data regarding the user's active arrest warrants and criminal record information. The questions, which may be contained in the adaptive questionnaire module 217, correspond to a litigant group that includes or is associated with that particular user. Each litigant group generally includes one or more similarly situated individuals to which a government official, e.g., member of the judiciary, has assigned identical or similar rules for resolving issues common within the litigant group. Examples of litigant groups include individuals with unpaid fines or past-due fines having a specified default period.

A judge or other government official may utilize the system (block 614) to define the litigant groups (block 616) by accessing information from a court case management system database (block 618). The information from the court case management system may include delinquent cases (block 620) and individual litigants (block 622). Each individual litigant is sorted into a litigant group defined by the judge (block 624). Each litigant group may be defined by filters, e.g., true/false questions, analytics, or metrics constructed by the judge (block 626). The filters facilitate segregating the litigants into subgroups eligible for resolution (block 628) via the system. In particular, offers to resolve the matter may depend on the answers provided by the litigant user. That is, some answers may contribute to placing the litigant into a group that will receive a less attractive offer to resolve the matter or perhaps no offer at all (block 630). For example, possible answers to the question, “Why did you miss your court date?” may include “I could not get time off work” and “I forgot my court date.” A judge may determine that litigants who select the latter answer be categorized in a litigant group that may be provided with a less attractive offer to resolve the matter. The offer invites the litigant to enter into a contract granting the litigant some form of relief. For example, the litigant group “failure to appear, non-violent misdemeanor” is eligible for an offer with the following terms: new court date and favorable consideration conditioned on posting of $50 performance bond.” If a litigant user is not associated with a litigant group, the litigant may not be eligible for resolution via the system.

In short, the presentation of questions to the user may be an adaptive process. That is, the specific question or questions presented to the user may be based at least in part on the user's response or responses to one or more previous questions. The presentation of questions to the user may also be at least partially randomized. The warrant resolution module 212 may choose between equally valid questions or eliminate certain questions from consideration and/or also decide which specific questions from adaptive questionnaire module 217 should be presented to the user.

The warrant resolution module 212 may also analyze and/or edit entries in the payout matrix module 215. For example, as the user answers questions from the adaptive questionnaire module 217, the decision module 219 may analyze the user's responses and eliminate certain deals contained in the payout matrix module from consideration when presenting the final deal to the user (e.g., if the user indicates that he is not willing to pay a fine, deals that incorporate paying a fine may not be considered when the final deal is presented to the user). As discussed above, the payout matrix module 215 may organize deals based on identified different classes of users (e.g., categories of criminal offenses, criminal history), may contain only a single category of deals (e.g., only deals for users with unresolved warrants for drug offenses), and/or may contain multiple categories of deals in the same matrix.

Upon determining a litigant group for the user (block 634) and receiving a request to the court (block 632), the warrant resolution module 212 may determine or generate a proposed warrant resolution deal for communication to the user (block 636). The proposed warrant resolution deal may be based on the litigant user's responses to the customized series of one or more questions and the series of deals stored in a data matrix. For example, as a litigant user answers questions, certain deals may be removed from consideration if the user indicates he is not interested in them. Additionally, certain deals may be removed from consideration based on the user's answers about the incident underlying his unresolved warrant. For example, if a user's answers indicate that he committed a robbery, he may be required to serve jail time, and deals that do not incorporate jail time may be removed from consideration. Further, as discussed above, there may be some randomization involved in the determination of the warrant resolution deal.

The warrant resolution deal may be conditional on the accuracy of the user's answers to the questionnaire. For example, if one or more of the answers provided by the user during the bargaining process was inaccurate, the surrender offer may be revoked after the process 600 is complete. The surrender offer may be communicated to the user in a variety of ways. For example, in certain implementations of the disclosed subject matter, an offer may be generated after a fixed time period or after a predetermined number of questions have been presented to the user. In other implementations, an offer may not be generated until the user has exhausted all the questions in or presented by the adaptive questionnaire module 217 relevant to his case. Alternatively, an offer may be generated at an arbitrary time in the bargaining process to add another element of randomization to the bargaining process. Surrender incentive offers may be “pre-approved,” so that no further action is required by any government actor in order for a given user to be offered an enforceable agreement (block 638). In other examples, discretionary review of an offer after it has been presented is used, for example, wherein a user's acceptance of an offer is communicated from a user device to a Judge's device for final approval. The offer may be automatically communicated to the user via e-mail, text, automated phone call, etc. (block 640). Notification that resolution of the warrant via the system is not available to the user may similarly be communicated to the user (block 642). Additionally, as discussed above, an artificial delay of several hours or days between receiving the user's final answer and presenting an offer to the user may be implemented. This aspect of the invention may preserve an appearance of individualization, especially if combined with a discretionary review policy (in which some percentage of offers are reviewed and potentially adjusted by the government), as the user would not know that his offer was produced automatically.

In certain implementations, the presented deal may be automatically binding. In other implementations (block 644), the user will have the option of either accepting the deal, and thus being legally bound by its terms, or rejecting the deal. If the user has the option of accepting or rejecting the deal, the warrant resolution module 212 may receive the user's acceptance or rejection of the presented proposed deal. If the user rejects the proposed deal, the user may not be eligible for future resolutions via the system (block 648) and the warrant resolution module 212 may delete nearly all information related to the user's application, with the exception of minimal identifying information required to prevent the user from going through a second automated bargaining process on the same warrant. Optionally, the user may be required to call a provided number and leave a voice sample to be stored indefinitely as a way to confirm the user's identity, in case a dispute arises over whether an agreement was accepted.

If the user accepts the proposed deal, a binding agreement may then be delivered electronically to the user and stored either on a local device or a remote device (block 646). Once the user has accepted the proposed deal, the user's identifying and offense information may be made freely accessible to an interested government entity for review or further processing. The user may also be given an opportunity to print a copy of the agreement.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain implementations are described herein as including logic or a number of components, modules, or mechanisms. Modules may constitute either software modules (e.g., code implemented on a tangible, non-transitory machine-readable medium such as RAM, ROM, flash memory of a computer, hard disk drive, optical disk drive, tape drive, etc.) or hardware modules (e.g., an integrated circuit, an application-specific integrated circuit (ASIC), a field programmable logic array (FPLA), etc.). A hardware module is tangible unit capable of performing certain operations and may be configured or arranged in a certain manner. In example implementations, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

Some implementations may be described using the expression “coupled” along with its derivatives. For example, some implementations may be described using the term “coupled” to indicate that two or more elements are in direct physical or electrical contact. The term “coupled,” however, may also mean that two or more elements are not in direct contact with each other, but yet still co-operate or interact with each other. The implementations are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for automated warranted resolution through the disclosed principles herein. Thus, while particular implementations and applications have been illustrated and described, it is to be understood that the disclosed implementations are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A device operative to automatically resolve a warrant, the device comprising:
a processing unit;
a memory unit; and
a warrant resolution module operative to:
retrieve login information associated with a device user;
confirm, based on the login information, that the device user is authorized to resolve the warrant;
present the device user with a customized series of one or more questions that inquire about the user's background, the incident or incidents which led to the warrant, and/or one or more warrant resolution deals that may be presented to the user, wherein the customized series of one or more questions is adjustable in response to i) one or more of the device user's responses to the customized series of one or more questions and/or ii) a series of deals stored in a data matrix;
determine a proposed warrant resolution deal based on the device user's responses to the customized series of one or more questions and the series of deals stored in a data matrix; and
present the device user with the proposed warrant resolution deal and request the device user accept the proposed warrant resolution deal or reject the proposed warrant resolution deal.

2. The device of claim 1 wherein the data matrix entries are pre-approved by a government agent.

3. The device of claim 2 wherein the warrant resolution module is further operative to:
delete data associated with the device user when the device user's response to the proposed warrant resolution deal rejects the proposed warrant resolution deal such that the deleted data cannot be accessed by a third party; and
generate and/or store data preventing the user from using the device to resolve the warrant again.

4. The device of claim 2 wherein the warrant resolution module is further operative to:
transmit the device user's response to the proposed warrant resolution deal and the proposed warrant resolution deal to a second device for review and/or approval by a government agent.

5. The device of claim 1 wherein the warrant resolution module is further operative to:
cross-reference a list of active warrants before presenting the device user with a customized series of one or more questions.

6. The device of claim 1 wherein the proposed warrant resolution deal comprises at least one of: a monetary fine, a prison term, a jail term, or community service.

7. The device of claim 1 wherein the data matrix entries are organized based on one or more categories of crimes associated with the entries.

8. The device of claim 1 wherein the data matrix entries are based on the criminal history of the device user.

9. The device of claim 1 wherein the warrant resolution module is further operative to:
anonymize the device user's identity.

10. The device of claim 1 wherein the customized series of one or more questions relate to information necessary to determine the likely consequences of the user's surrender and/or incentives that may be offered to the device user in order to induce a favorable resolution.

11. The device of claim 1 wherein the proposed warrant resolution deal is randomized.

12. The device of claim 1 wherein the warrant resolution module is further operative to: remove and/or edit deals stored in the data matrix.

13. The device of claim 1 wherein the warrant resolution module communicates with one or more remote databases to confirm that the device user is authorized to resolve the warrant.

14. The device of claim 1 wherein the warrant resolution module communicates with one or more remote databases access data related to the user's background and/or the incident or incidents which led to the warrants.

15. A computer-readable storage medium having stored thereon instructions executable by a processor to cause the processor to perform a method of automatically resolving a warrant, the method comprising:
retrieving login information associated with a device user;
confirming, based on the login information, that the device user is authorized to resolve the warrant;
presenting the device user with a customized series of one or more questions;
adjusting the customized series of one or more questions based on i) one or more of the device user's responses to the customized series of one or more questions and ii) a series of deals stored in a data matrix; and
presenting the device user with a proposed warrant resolution deal based on i) one or more of the device user's responses to the customized series of one or more questions and ii) the series of deals stores in a data matrix.

16. The computer-readable storage medium of claim 15 wherein the method further comprises:
receiving the device user's response to the proposed warrant resolution deal; and
further processing the device user's response to the proposed warrant resolution deal.

17. The computer-readable storage medium of claim 16 wherein the method further comprises:
deleting data associated with the device user when the device user's response to the proposed warrant resolution deal rejects the proposed warrant resolution deal.

18. The computer-readable storage medium of claim 16 wherein the method further comprises:
transmitting the device user's response to the proposed warrant resolution deal and the proposed warrant resolution deal to a second device for further processing.

19. The computer-readable storage medium of claim 15 wherein the method further comprises:
cross-referencing a list of active warrants before presenting the device user with a customized series of one or more questions.

20. The computer-readable storage medium of claim 15 wherein the proposed warrant resolution deal comprises at least one of: a monetary fine, a prison term, a jail term, or community service.

21. A method in a computing device having a processor of automatically resolving a warrant, the method comprising:
automatically retrieving, using the processor, login information associated with a computing device user;
automatically confirming, using the processor and based on the login information, that the device user is authorized to resolve the warrant;
automatically presenting, using the processor, the computing device user with a customized series of one or more questions;
automatically adjusting, using the processor, the customized series of one or more questions based on i) one or more of the computing device user's responses to the customized series of one or more questions and ii) a series of deals stored in a data matrix; and
automatically presenting, using the processor, the computing device user with a proposed warrant resolution deal based on i) one or more of the device user's responses to the customized series of one or more questions and ii) the series of deals stores in a data matrix.

22. The method of claim 21 further comprising:
receiving the device user's response to the proposed warrant resolution deal; and
further processing the device user's response to the proposed warrant resolution deal.

23. The method of claim 22 further comprising:
deleting data associated with the device user when the device user's response to the proposed warrant resolution deal rejects the proposed warrant resolution deal.

24. The method of claim 22 further comprising:
transmitting the device user's response to the proposed warrant resolution deal and the proposed warrant resolution deal to a second device for further processing.

25. The method of claim 21 further comprising:
cross-referencing a list of active warrants before presenting the device user with a customized series of one or more questions.

26. The method of claim 21 wherein the proposed warrant resolution deal comprises at least one of: a monetary fine, a prison term, a jail term, or community service.

27. A device operative to automatically perform a negotiable transaction, the device comprising:
a processing unit;
a memory unit; and
a negotiable transaction module operative to:
retrieve login information associated with a device user;
confirm, based on the login information, that the device user is authorized to participate in the negotiable transaction;
present the device user with a customized series of one or more questions that inquire about the user's background, incident or incidents related to the negotiable transaction, and/or one or more proposed deals that may be presented to the user, wherein the customized series of one or more questions is adjustable in response to i) one or more of the device user's responses to the customized series of one or more questions and/or ii) a series of deals stored in a data matrix;
determine a proposed deal based on the device user's responses to the customized series of one or more questions and the series of deals stored in a data matrix; and
present the device user with the proposed deal and request the device user accept the proposed conflict resolution deal or reject the proposed warrant resolution deal.

28. The device of claim 27 wherein the negotiable transaction comprises at least one of: an unresolved warrant, a college admission decision, a financial aid decision, and debt resolution.
